(19) United States
(12) Patent Application Publication
(10) Pub. No.: US 2003/0118287 A1
(43) Pub. Date: Jun. 26, 2003

(54) Method for designing polarization maintaining couplers

(75) Inventor: Kevin W. Shirk, Sunnyvale, CA (US)

Correspondence Address: Pacific Law Group, LLP, 7394 Wildflower Way, Cupertino, CA, 95014, US

(73) Assignee: Alliance Fiber Optic Products, Inc., Sunnyvale, CA (US)

(21) Appl. No.: 10/028,943

(22) Filed: Dec. 21, 2001

(51) Int. Cl. G02B 6/26

(52) U.S. Cl. 385/39

(57) ABSTRACT

Techniques for designing, configuring or manufacturing polarization maintaining couplers (e.g. fiber arrays or splitters) are disclosed. According to one embodiment, a pair of polarization maintaining couplers are designed by a method including forming V-shaped troughs in two platforms (e.g. silicon based); placing two fibers respectively in the troughs so that both of the platforms can be closed up as a whole part; and obtaining the pair of the polarization maintaining couplers by a precision cut of the whole part somewhere in the middle thereof.

### BACKGROUND OF THE INVENTION

1. Technical Field

The invention relates to fiber optical couplers. More particularly, the invention relates to method and apparatus for making polarization maintaining couplers that require no individual rotational alignment thereto.

2. Description of the Prior Art

Optical telecommunications generally involves the use of light beams propagating through optical fibers to transmit data from one end to another end. When an optical fiber carrying an input data signal that needs to be connected to two destinations, the signal needs to be split into two. This is achieved in the art by a coupler. When used for the splitting purpose, it is often referred to as a splitter. Generally, a coupler is bi-directional. When a coupler is used to combine two signals respectively from two sources, the coupler is used as a combiner to combine the two signals onto a single optical fiber.

As the light beams travel through the optical fiber, they may be distorted by the fiber in a number of ways. One type of distortion caused by optical fiber is polarization mode dispersion, which refers to an effect that an optical device may have on a different polarization of a light beam. To maintain the polarization of a light beam, polarization maintaining fibers (PMF) are often used and characterized in that they maintain the polarization of an input light signal throughout the entire length of the fibers.

In general, these fibers have two principal axes of propagation of an optical signal within them, called the vertical or horizontal axis, or sometimes referred to as a “fast” or a “slow” axis. The axes are substantially perpendicular to each other and can have different characteristics. The fast axis has a refractive index which is substantially lower than that of the slow axis, and therefore enables the light beam polarized in the same direction to travel along the fiber at a higher phase velocity than that of the light beam polarized in the direction of the slow axis. In both directions, however, the signal is kept substantially unaltered at the output of the fiber.

Along the fibers, there can be many optical signal processing components or devices that require couplers to facilitate the polarized light beam in or out of the components or devices. To maintain the polarization of a light beam, these couplers must be able to maintain the polarization of the light beam. The current efforts in producing polarization maintaining couplers include individual alignment of couplers after they are designed or manufactured. It is well known that the individual alignment is labor intensive and subsequently becomes a substantial factor in the cost of these couplers.

There is, therefore, a solution for producing polarization maintaining couplers (e.g. fiber splitters or fiber combiners) in much efficient, more accurate and cost-effective way.

### SUMMARY OF THE INVENTION

The present invention, generally speaking, provides a method for designing, configuring or manufacturing a pair of polarization maintaining couplers. In some applications, the polarization maintaining couplers are also referred to as polarization maintaining fiber arrays that can be used as splitters or combiners. According to one embodiment, the present invention is a method for producing a pair of polarization maintaining couplers, the method comprising: forming V-shaped troughs in two platforms (e.g. silicon based); placing two fibers respectively in the troughs so that both of the platforms can be closed up as a whole part; and obtaining the pair of the polarization maintaining couplers by a precision cut of the whole part somewhere in the middle thereof.

According to another embodiment, the present invention is an optical apparatus of using a first and second polarization maintaining fiber arrays or couplers. The apparatus comprising: a waveguide structure having a main channel and a side channel, (i.e. a through port and a tap port), the side channel branching out from the main channel within the waveguide structure; each of the polarization maintaining couplers having two ports; and wherein the waveguide structure is coupled between the polarization maintaining couplers, one of the two ports of the first polarization maintaining coupler connecting to the main channel of the waveguide structure, when a polarized light beam is coupled into the main channel (i.e. the through port) via the one of the two ports of the first polarization maintaining coupler, a small amount of the polarized light beam is diverted into the side channel (i.e. the tap port).

The first and second polarization maintaining fiber arrays or couplers are configured by a method including: etching at least one trough respectively in each of two silicon structures; stripping a center portion of a fiber so that the fiber can be securely positioned in the trough of the two silicon structures; combining the two silicon structures with the center portion of the fiber therebetween to form a whole structure; and cutting the whole structure into two parts, each becoming one of the polarization maintaining couplers.

One of the objects of the present invention is to provide an effective solutions for designing, configuring, or manufacturing polarization maintaining tap couplers.

Other objects, features, and advantages of the present invention will become apparent upon examining the following detailed description of an embodiment thereof, taken in conjunction with the attached drawings.

### BRIEF DESCRIPTION OF THE DRAWINGS

FIG. 1A shows a perspective view of two polarization maintaining (PM) couplers coupled with an optical device;

FIG. 1B shows a top-view of FIG. 1A;

FIG. 2 shows two optical fibers that have the center portions and stripped;

FIG. 3A shows a silicon structure in which V-shaped troughs (shown as unshaded areas in the middle part), often referring to as V-grooves;

FIG. 3B shows another possible structure.

FIG. 3C shows that the center stripped fibers being placed in the silicon structure shown in FIG. 3A;

FIG. 4A shows that the two structures are bonded together with the center stripped fibers placed in the V-grooves between the two structures;

FIG. 4B shows that the integrated part is being cut into two separate parts, side A and side B, that correspond to the couplers in FIG. 1A and FIG. 1B; and

FIG. 5 illustrates a cross section view of the two PM fiber arrays or couplers.

### DETAILED DESCRIPTION OF THE INVENTION

The present invention pertains to techniques for producing polarization maintaining couplers in much efficient, more accurate and cost-effective way. According to one embodiment, a pair of fibers, preferably, a single mode fiber and a polarization maintaining fiber, are embedded in two platforms that can be closed up as a whole part. A precision cut somewhere in the middle of the whole part results in two polarization maintaining couplers that no longer requires manual or labor intensive alignment of the two polarization maintaining couplers when used together with other optical parts.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

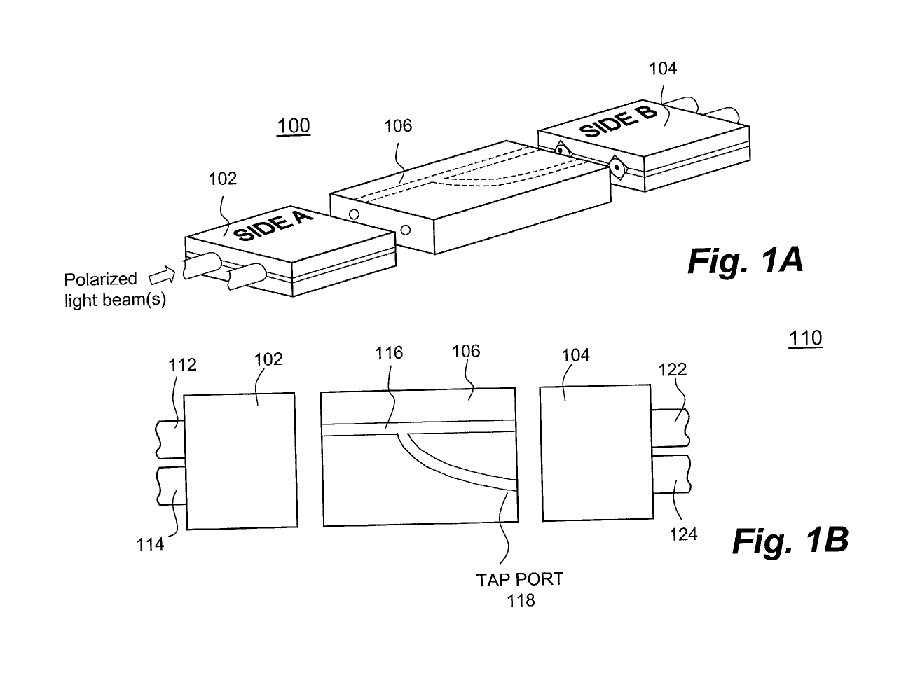

Referring now to the drawings, in which like numerals refer to like parts throughout the several views. FIG. 1A shows a perspective view 100 of two polarization maintaining (PM) fiber arrays or couplers 102 and 104 coupled with an optical device 106. In one application, each of the PM couplers 102 and 104 has two ports, one connecting to a single mode (SM) fiber and the other connecting to a polarization maintaining (PM) fiber. In operation, a polarized light beam comes from a PM fiber and one of the two ports of the PM coupler 102 receives the beam therefrom. According to one embodiment, the other port of the two ports of the PM coupler 102 is not used. The polarized light beam is then coupled to the optical device 106 that transmits the beam to the PM coupler 104. To monitor the transmitting beams, a very small amount (e.g. 0.5% or 1%) of the transmitting beam in the optical device 106 are diverted to one of the two ports of the PM coupler 104 that is for connecting the single mode fiber. The rest of the beam is coupled to the other port (PM) of the coupler 104. One of the features in the present invention is that neither of the PM couplers 102 and 104 requires alignment. They are manufactured in such a manner that guarantees that both the PM couplers are in perfect alignment.

The optical device 106 may be, but not be limited to, collimators, circulators, and various PLC waveguide devices. To facilitate the description of the present invention, the optical device 106 is a planar waveguide that facilitates diverting the small amount of the transmitting beam for monitoring purposes. Those skilled in the art will be able to apply the present invention to other structures, devices or systems given the description herein.

Referring now to FIG. 1B, there is shown a top-view 110 of FIG. 1A and shall be understood in conjunction with FIG. 1A. A polarized light beam or beams come to a PM port 112 of the PM coupler 104. According to one embodiment, the PM port 112 also has an unused port 114 that is more or less a byproduct of the embodiment of the present invention. The polarized beams are coupled to a waveguide 116 embedded/configured in a planar waveguide chip 120. The waveguide 116 leads the beam to a PM port 122 of the PM coupler 104. The planar waveguide chip 120 also includes a side waveguide 118 branching out from the waveguide 116. The side waveguide 118 is sometimes referred to as a tapping waveguide connected to a tap port. One of the functions of the tapping waveguide 118 is to divert a small amount of beam energy from the polarized beam transmitting in the waveguide 116 for monitoring purposes. As shown in FIG. 1B, the diverted beam is coupled to the SM port 124 of the PM coupler 104 and the rest of the polarized beam goes to the port 122 of the PM coupler.

To understand the present invention, it is deemed necessary to illus designed and guaranteed to be aligned according to one embodiment of the present invention. The order of drawings shall not be interpreted as limitations to the invention. In fact, in conjunction of the description, those skilled in the art can reorder the sequence of the drawings to produce various PM couplers having substantially the same characteristics.

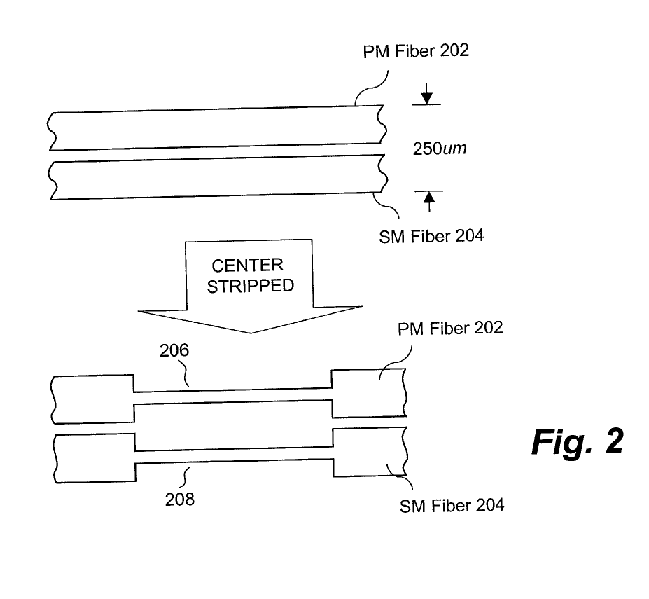

Referring now to FIG. 2, there are shown two optical fibers 202 and 204 that have the center or window portions 206 and 208 stripped. Generally, a fiber for communication comprises a glass fiber core protected by one or more layers surrounding the glass fiber. Depending on the use of the fiber, the inner layer or layers can have spectral characteristics very different from one fiber to another. Also, a fiber may be classified as single mode or multimode. A single mode fiber is designed for transmission of a single ray or mode of light as a carrier and is used for long-distance signal transmission. As the name suggests, a multimode fiber is designed to carry multiple light rays or modes concurrently, each at a slightly different reflection angle within the optical fiber core. Multimode fiber transmission is used for relatively short distances because the modes tend to disperse over longer lengths.

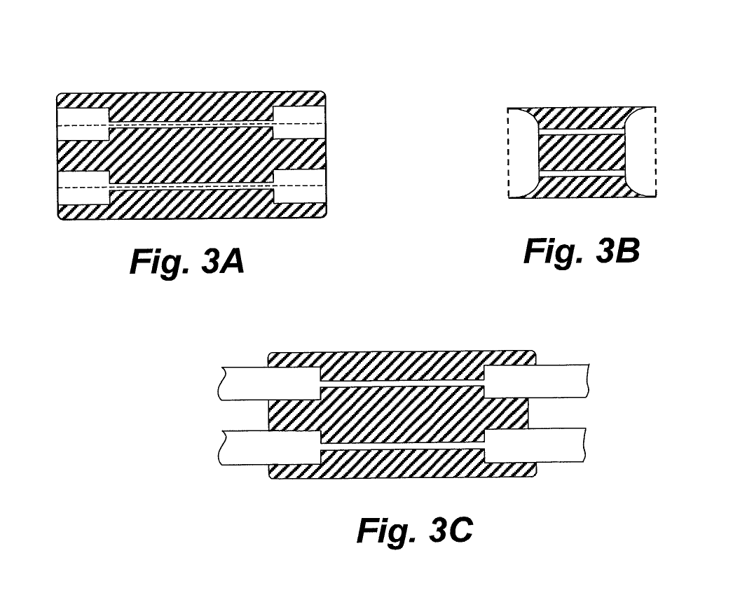

FIG. 3A shows a silicon structure 300 in which V-shaped troughs (shown as unshaded areas), often referring to as V-grooves, are formed or etched. FIG. 3B shows another possible structure 310. One of the functions of the structures 300 or 310 is to securely hold up the center stripped fibers 202′ and 204′ in the V-grooves. FIG. 3C shows that the center or window stripped fibers 202′ and 204′ are being placed in the silicon structure 300. According to one embodiment, a bonding agent (e.g. epoxy or solder) is used to bond the fibers 202′ and 204′ to silicon structure 300.

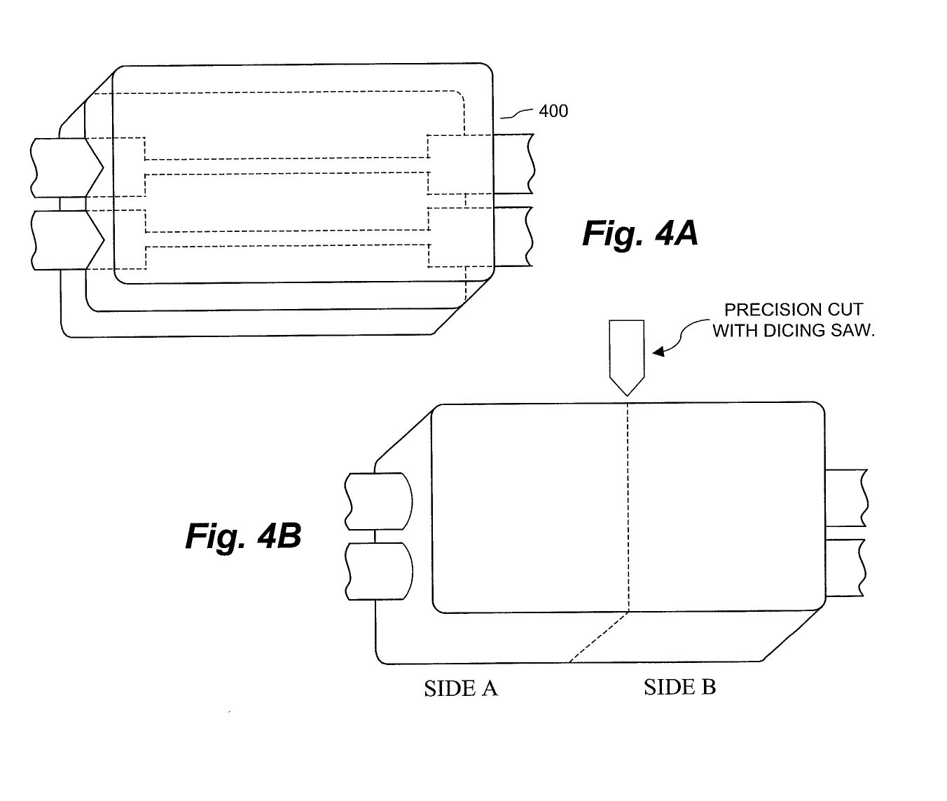

Another silicon structure substantially identical to the silicon structure 300 is then placed onto the silicon structure 300 with the center stripped fibers 202′ and 204′ in. FIG. 4A shows that the structures 300 and 300′ are bonded together with the center stripped fibers 202′ and 204′ placed in the V-grooves therebetween. According to one embodiment, a bonding agent is applied to ensure that the structures 300 and 300′ are now formed as a whole integrated part 400.

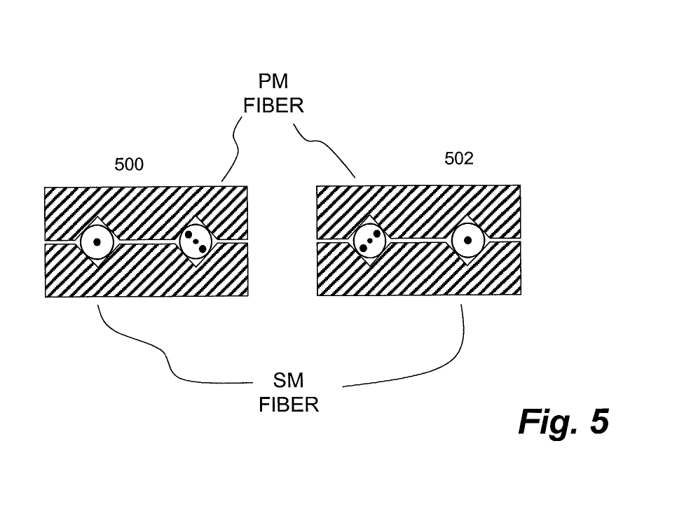

Referring now to FIG. 4B, there is shown that the integrated part 400 is being cut into two separate parts, side A and side B, that correspond to the couplers in FIG. 1A and FIG. 1B. According to one embodiment, a piecing saw is used to make a precision cut. As a result, two couplers are made. What is more is that the two couplers do not need aligned because they are cut from the same piece and have a perfect alignment between them. FIG. 5 illustrates a cross section view of the two PM couplers 500 and 502. Both have the PM fiber and the SM fiber. The important feature is that both PM fibers in the two PM couplers 500 and 502 are perfectly aligned. Hence there is no need to perform individual alignment after a coupler is made. As it can be understood, the stress rods in the PM fibers in either one of the PM couplers 500 and 502 are in mirror positions, reflecting a perfect alignment of the PM couplers 500 and 502.

There are many advantages and benefits in the present invention. One of them is that the present invention requires no individual alignment of PM couplers after they are made. Another advantage and benefit is that the method of designing PM couplers disclosed herein makes the couplers more accurate, less expensive, and more manufacturable.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, the structure to hold the center-stripped fibers may be formed from a material other than silicon. Also the troughs that hold the fibers may be of other shapes. Accordingly, the scope of the present invention is defined by the appended claims rather than the forgoing description of embodiments.

I claim:

1. A method for producing a pair of polarization maintaining couplers, the method comprising:
forming troughs in two platforms;
placing two fibers respectively in the troughs so that both of the platforms can be closed up as a whole part; and
obtaining the pair of the polarization maintaining couplers by a precision cut of the whole part somewhere in the middle thereof.

2. The method of claim 1 further comprising bonding the two fibers in the troughs by applying a bonding agent thereto.

3. The method of claim 2, wherein the placing of the two fibers respectively in the troughs comprises bonding the two platforms together with the two fibers therebetween.

4. The method of claim 1 wherein each of the two fibers has a glass core for optical signals to propagate therein and the glass core is protected and surrounded by one or more outer layers.

5. The method of claim 4, wherein the placing of the two fibers respectively in the troughs comprises:
stripping some of the one or more outer layers off each of the two fibers in a middle portion thereof;
securing the stripped middle portions of the two fibers respectively in the troughs; and
bonding the two platforms together with the two fibers therebetween.

6. The method of claim 5, wherein the troughs are of V-shape.

7. The method of claim 6, wherein the troughs are straight to facilitate a placement of the stripped middle portions of the two fibers in the two platforms.

8. The method of claim 6, wherein the two platforms are silicon based.

9. The method of claim 1, wherein between the two fibers, one is a single mode fiber and the other is a polarization maintaining fiber.

10. A method for producing a pair of polarization maintaining couplers, the method comprising:
etching at least one trough respectively in each of two silicon structures;
stripping a center portion of a fiber so that the fiber can be securely positioned in the trough of the two silicon structures;
combining the two silicon structures with the center portion of the fiber therebetween to form a whole structure; and
cutting the whole structure into two parts, each becoming one of the polarization maintaining couplers.

11. The method of claim 10, wherein the trough is of V-shape.

12. The method of claim 10, wherein the fiber has a glass core for optical signals to propagate therein and the glass core is protected and surrounded by one or more outer layers; and wherein the stripping of the center portion of the fiber comprises stripping some of the one or more layers off the fiber for a predetermined length of the fiber.

13. The method of claim 10, wherein the combining of the two silicon structures comprises applying a bonding agent between the two silicon structures.

14. An apparatus of using a first and second polarization maintaining couplers, the apparatus comprising:
a waveguide structure having a main channel and a side channel, the side channel branching out from the main channel within the waveguide structure;
each of the polarization maintaining couplers having two ports; and
wherein the waveguide structure is coupled between the polarization maintaining couplers, one of the two ports of the first polarization maintaining coupler connecting to the main channel of the waveguide structure, when a polarized light beam is coupled into the main channel via the one of the two ports of the first polarization maintaining coupler, a small amount of the polarized light beam is diverted into the side channel.

15. The apparatus of claim 14, wherein the small amount of the polarized light beam diverted into the side channel is coupled to another one of the two ports of the second polarization maintaining coupler and output to a signal mode fiber.

16. The apparatus of claim 14, wherein the first and second polarization maintaining couplers are configured by a method including:
etching at least one trough respectively in each of two silicon structures;
stripping a center portion of a fiber so that the fiber can be securely positioned in the trough of the two silicon structures;
combining the two silicon structures with the center portion of the fiber therebetween to form a whole structure; and
cutting the whole structure into two parts, each becoming one of the polarization maintaining couplers.

17. The apparatus of claim 14, wherein the main channel is for communicating the polarized light.

18. The apparatus of claim 14, wherein another one of the two ports of the polarization maintaining couplers is not used.
